(19) United States
(12) Patent Application Publication
(10) Pub. No.: US 2023/0052479 A1
(43) Pub. Date: Feb. 16, 2023

(54) Systems and Methods for Dynamic Data Propagation Across Platforms

(71) Applicant: Google LLC, Mountain View, CA (US)

(72) Inventors: Loc Thi Bao Do, Irvine, CA (US); Eric Joshua Burley, Irvine, CA (US); Matthew Grant Matyas, Irvine, CA (US); Charbel Zaarour, Woodinville, WA (US)

(21) Appl. No.: 17/973,338

(22) Filed: Oct. 25, 2022

Related U.S. Application Data
(63) Continuation of application No. PCT/IB2021/051870, filed on Mar. 5, 2021.

(30) Foreign Application Priority Data
Aug. 31, 2020 (VN) 1-2020-05021

(51) Int. Cl. G06F 8/65; G06F 9/445; G06F 8/71

(52) U.S. Cl. CPC G06F 8/65; G06F 9/44505; G06F 8/71

(57) ABSTRACT

One method includes providing a plurality of events defined for a mobile application; providing a plurality of configuration options for the events, wherein the plurality of configuration options may include parameters; receiving an update to a first configuration option of the plurality of configuration options for a first event of the plurality of events in the list and a first parameter associated with the update; storing the updated first configuration option; transmitting to a first client device of a plurality of client devices running the mobile application, the updated first configuration option, wherein the updated first configuration option may cause the mobile application to monitor data of the mobile application for the occurrence of the first parameter; receiving from the first client device responsive to the first client device detecting the occurrence of the configuration option.

### CROSS-REFERENCE TO RELATED APPLICATION

This application claims priority to Vietnamese Patent Application No. 1-2020-05021, filed on Aug. 31, 2020, the contents of which are incorporated herein by reference.

### BACKGROUND

Implementations of the present disclosure relate generally to the propagation of configurations to applications across various platforms. In particular, they relate to systems and methods for dynamic configuration and without alterations to the code representative of the applications.

Traditionally, applications utilizing analytics frameworks are hindered by a cumbersome process when a need arises to modify their analytics configurations. An application must be recoded and re-released to the market in order to effect change. Additionally, widespread adoption of the update may be difficult to attain, as many users update their applications on an infrequent basis.

### SUMMARY

One aspect of the present disclosure relates to a method. The method may include providing, by the one or more processing circuits of the event analysis computer system to a developer device, a plurality of events defined for an application. The method may include providing, by the one or more processing circuits, to the developer device, a plurality of configuration options for the events. The plurality of configuration options may include parameters. The method may include receiving, by the one or more processing circuits from the developer device, an update to a first configuration option of the plurality of configuration options for a first event of the plurality of events in the list and a first parameter associated with the update. The method may include storing, by the one or more processing circuits, the updated first configuration option. The method may include transmitting, by the one or more processing circuits to a first client device of a plurality of client devices running the application, the updated first configuration option. The updated first configuration option may cause the application to monitor data of the application for the occurrence of the first parameter. The method may include receiving, by the one or more processing circuits from the first client device responsive to the first client device detecting the occurrence of the first parameter, a new event or a modified event based on the updated first configuration option.

In some implementations of the method, the parameters may include a plurality of Boolean operators and a plurality of conditions and provide for selection on the developer device of multipart conditional parameters.

In some implementations of the method, at least one action may be performed for each parameter associated with each event in the list of events.

In some implementations of the method, the plurality of configuration options further includes event names and parameter actions.

In some implementations of the method, it may further include receiving, by the one or more processing circuits from the developer device, a version selection indicating a first version of the application from among a plurality of versions. In some implementations of the method, transmitting the updated first configuration option to the first client device may include transmitting the updated first configuration option responsive to determining a version of the application installed on the first client device is the first version.

In some implementations of the method, it may further include receiving, by the one or more processing circuits from the developer device, a data stream selection indicating a first data stream category of the application from among a plurality of data stream categories. In some implementations of the method, transmitting the updated first configuration option to the first client device may include transmitting the updated first configuration option responsive to determining a data stream category associated with the first client device is the first data stream category.

In some implementations of the method, the update to the configuration options may cause the first parameter to parameter an additional new event. In some implementations of the method, the additional new event may be selected based on the data stream and version selector status.

In some implementations of the method, the plurality of configuration options further comprises an option to delete an existing account.

Another aspect of the present disclosure relates to a system. The system may include one or more computer-readable storage media having instructions stored thereon. The system may also include one or more processors configured to execute the instructions. The processor(s) may be configured to provide, to a developer device, a plurality of events defined for an application. The processor(s) may be configured to provide, to the developer device, a plurality of configuration options for the events. The plurality of configuration options may include parameters. The processor(s) may be configured to receive, from the developer device, an update to a first configuration option of the plurality of configuration options for a first event of the plurality of events in the list and a first parameter associated with the update. The processor(s) may be configured to store, the updated first configuration option. The processor(s) may be configured to transmit, to a first client device of a plurality of client devices running the application, the updated first configuration option. The updated first configuration option may cause the application to monitor data of the application for the occurrence of the first parameter. The processor(s) may be configured to receive, from the first client device responsive to the first client device detecting the occurrence of the first parameter, a new event or a modified event based on the updated first configuration option.

In some implementations of the system, the parameters may include a plurality of Boolean operators and a plurality of conditions and provide for selection on the developer device of multipart conditional parameters.

In some implementations of the system, the plurality of configuration options further includes event names and parameter actions.

In some implementations of the system, the processor(s) may be configured to receive, from the developer device, a version selection indicating a first version of the application from among a plurality of versions. In some implementations of the system, transmitting the updated first configuration option to the first client device may include transmitting the updated first configuration option responsive to determining a version of the application installed on the first client device is the first version.

In some implementations of the system, the processor(s) may be configured to receive, from the developer device, a data stream selection indicating a first data stream category of the mobile application from among a plurality of data stream categories. In some implementations of the system, transmitting the updated first configuration option to the first client device may include transmitting the updated first configuration option responsive to determining a data stream category associated with the first client device is the first data stream category.

In some implementations of the system, the update to the configuration options may cause the first parameter to activate an additional new event. In some implementations of the system, the additional new event may be selected based on the data stream and version selector status.

Yet another aspect of the present disclosure relates to a computer-readable storage media having instructions stored thereon, the instructions being executable by one or more processors to perform operations. The computer-readable storage media may be non-transitory. The operations may include providing, to a developer device, a plurality of events defined for an application. The operations may include providing, to the developer device, a plurality of configuration options for the events. The plurality of configuration options may include parameters. The operations may include receiving, from the developer device, an update to a first configuration option of the plurality of configuration options for a first event of the plurality of events in the list and a first parameter associated with the update. The operations may include storing, the updated first configuration option. The operations may include transmitting, to a first client device of a plurality of client devices running the application, the updated first configuration option. The updated first configuration option may cause the application to monitor data of the application for the occurrence of the first parameter. The operations may include receiving, from the first client device responsive to the first client device detecting the occurrence of the first parameter, a new event or a modified event based on the updated first configuration option.

In some implementations of the one or more computer-readable storage media, the parameters may include a plurality of Boolean operators and a plurality of conditions and provide for selection on the developer device of multipart conditional parameters.

In some implementations of the one or more computer-readable storage media, at least one action may be performed for each parameter associated with each event in the list of events.

In some implementations of the one or more computer-readable storage media, the plurality of configuration options further includes event names and parameter actions.

In some implementations of the one or more computer-readable storage media, the operations may include further including receiving, from the developer device, a version selection indicating a first version of the application from among a plurality of versions. In some implementations of the one or more computer-readable storage media, transmitting the updated first configuration option to the first client device may include transmitting the updated first configuration option responsive to determining a version of the application installed on the first client device is the first version.

In some implementations of the one or more computer-readable storage media, the operations may include further including receiving, from the developer device, a data stream selection indicating a first data stream category of the application from among a plurality of data stream categories. In some implementations of the one or more computer-readable storage media, transmitting the updated first configuration option to the first client device may include transmitting the updated first configuration option responsive to determining a data stream category associated with the first client device is the first data stream category.

### BRIEF DESCRIPTION OF THE DRAWINGS

The details of one or more implementations of the subject matter described in this specification are set forth in the accompanying drawings and the description below. Other features, aspects, and advantages of the subject matter will become apparent from the description, the drawings, and the claims.

FIG. 1 is a schematic diagram of an event analysis system including a client device, a developer device, and an event analysis computer system, according to an illustrative implementation.

FIG. 2 is a flow diagram of a method for dynamically propagating configuration options to an application, according to an illustrative implementation.

FIG. 3 is a block diagram of an application proprietor use case, according to an illustrative implementation.

FIG. 4A is an example of an event analytics dashboard, according to an illustrative implementation.

FIG. 4B is an example of an event analytics dashboard, according to an illustrative implementation.

FIG. 4C is an example of an event analytics dashboard, according to an illustrative implementation.

FIG. 5 is a block diagram of a computing system according to an illustrative implementation.

### DETAILED DESCRIPTION

Referring generally to the figures, systems and methods for dynamically modifying and propagating application configurations are shown and described. The application configurations may be propagated in such a manner that they may be utilized without recoding or updating an application. Furthermore, the features implemented by the present disclosure represent both technological and convenience improvements to the current analytics environment.

It should be appreciated that while the present disclosure discusses many features in relation to mobile applications, various implementations utilize said features with non-mobile applications as well.

Various improvements to the technology associated with application analytics are described herein. Many applications contain analytic frameworks that generate events in response to the behavior exhibited inside an application. The generated events may include statistics, error alerts, resource usage reports, or any variety of data generation responsive to the behavior exhibited inside an application. The behavior exhibited inside an application may encompass any variety of quantifiable data, such as processor(s) load, network utilization, memory utilization, error frequency, etc. At times, the application developer may wish to change one or more of the event configurations. Traditionally, applications utilizing an event analytics framework require version updates in order to achieve event configuration modifications. As should be appreciated, especially with regards to privacy goals, recoding a new version of an application to implement modifications to the event configurations is highly disadvantageous.

Typically, recoding a new version of an application inherently contains significant overhead and time delay. Additionally, recoding the application may require scheduling with professional software developers to incorporate the desired changes. Furthermore, completion of the new application version provides no assurances that the desired changes are propagated to the client devices, as the users often must download the update in order to receive the change. For example, an application may have an analytics framework that generates an event erroneously, due to a mistake in the configuration. Every time that the application generates the erroneous event, it is consuming device resources (e.g., power, memory space, processing potential, etc.) and network bandwidth, both on the client device and the event analysis computer system. This waste of technological resources may not be remedied in full by a version update, as each user running an older version of the application will continue to consume resources reporting the erroneous event. Further, the network and infrastructure usage required in order for each user to install an application update (and avoid resource consumption by the erroneous event) can be significant where many thousands or even millions of users are involved. As such, the features of the present disclosure described herein, provide a more efficient solution in that desired changes can be incorporated without the need for a full updated install on every client device.

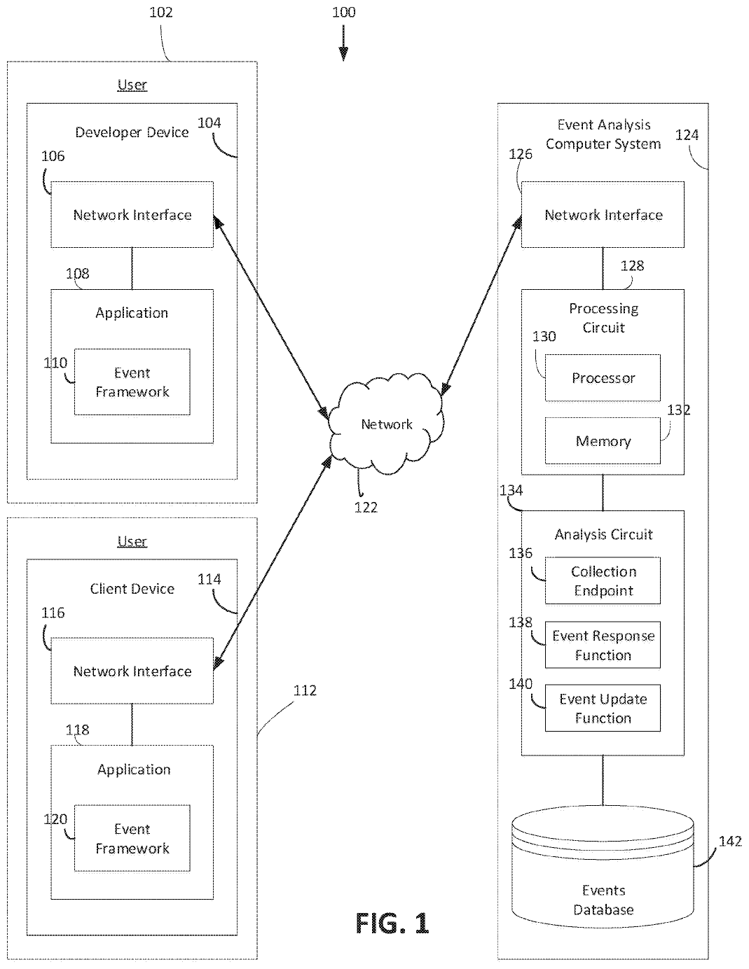

Referring to FIG. 1, a schematic design of an event analysis system 100, is shown according to an illustrative implementation. The event analysis system 100 includes a developer device 104, a client device 112, and an event analysis computer system 124. The developer device 104, the client device 112, and the event analysis computer system 124 are each communicably coupled and configured to exchange information over a network 122, which may include one or more of the Internet, cellular network, Wi-Fi, Wi-Max, or any other type of wired or wireless network.

The developer device 104 may be any of a variety of devices associated with a user 102. For example, the developer device 104 may comprise a mobile phone, a personal computer (e.g., a desktop computer or a laptop computer), a tablet, a smart watch or other wearable device, a virtual/augmented reality (VR/AR system), and/or any other suitable user computing devices capable of accessing and communicating using local and/or global networks (e.g., the network 122).

The developer device 104 comprises a network interface 106, an application 108, and an event framework 110. The network interface 106 is used to establish connections with other computing systems and devices (e.g., the event analysis computer system 124) by way of the network 122. Accordingly, the network interface 106 enables the developer device 104 to transmit and/or receive information to and/or from the event analysis computer system 124 or any other network enabled device. The network interface 106 includes program logic that facilitates connection of the developer device 104 to the network 122. For example, the network interface 106 may include any combination of a wireless network transceiver (e.g., a cellular modem, a Bluetooth transceiver, a WiFi transceiver, etc.) and/or a wired network transceiver (e.g., an Ethernet transceiver). In some arrangements, the network interface 106 includes the hardware and machine-readable media sufficient to support communication over multiple channels of data communication. Further, in some arrangements, the network interface 106 includes cryptography capabilities to establish a secure or relatively secure communication session in which data communicated over the session is encrypted.

In some implementations, the application 108 is a separate software application implemented on the developer device 104. In some implementations, the application may be implemented as a mobile application for use with mobile user devices. In other implementations, the application may be a non-mobile application, such as an application on a desktop computing system. For example, the application 108 may be downloaded by the developer device 104 prior to its usage (e.g., Apple App Store, Google Play Store, etc.). Furthermore, the application 108 may be of any form or function and be associated with any author of applications. The application 108 is configured to include an event framework 110 that facilitates the conditional generation and relay of events to an event analysis computer system 124. The event framework 110 may comprise an application programming interface (API) and/or software development kit (SDK) that is structured to transmit events and receive configuration options from the event analysis computer system 124. For example, the event framework 110 may be structured to monitor for specific and conditional interactions with the application 108 (e.g., clicks, screen time, data input, in-app purchases, etc.) and subsequent to identifying a conditional interaction, the event framework 110 generates an event correlated to the conditional interaction, and transmits it to the event analysis computer system 124.

Still referring to FIG. 1, the client device 106 comprises a network interface 116, an application 118, and an event framework 120. The client device 106 may be any of a variety of devices associated with a user 112. For example, the client device 106 may comprise a mobile phone, a personal computer (e.g., a desktop computer or a laptop computer), a tablet, a smart watch or other wearable device, a virtual/augmented reality (VR/AR system), and/or any other suitable user computing devices capable of accessing and communicating using local and/or global networks (e.g., the network 122).

The network interface 116 is similarly structured and used to establish connections with other computing systems (e.g., the event analysis computer system 124) by way of the network 122. The network interface 116 may further include any or all of the components discussed above, with reference to the network interface 106 of the developer device 104.

The application 118 and event framework 120 are similarly structured and used as on the developer device 106, in order to generate and relay events to the event analysis computer system 124. It should be appreciated that the application 118 is not associated with any particular author of applications, however, the application 108 of the developer device 106 and the application 118 of the client device 106 are generally the same application (device/platform differences and version differences are permitted).

Still referring to FIG. 1, the event analysis computer system 124 may be implemented using any type of computing system, such as a discrete server, a group of two or more computing devices/servers, a distributed computing network, a cloud computing network, and/or any other type of computing system capable of accessing and communicating using local and/or global networks (e.g., the network 122). The event analysis computer system 124 comprises a network interface 126, a processing circuit 128, an analysis circuit 134, and an events database 142.

The network interface 126 is similarly structured and used to establish connections with other computing systems (e.g., the developer device 104, the client device 114) by way of the network 122. The network interface 126 may further include any or all of the components discussed above, with reference to the network interface 106 of the developer device 104 and the network interface 116 of the client device 114.

The processing circuit 128 includes a processor 130 and a memory 132. The processor 130 may be implemented as one or more application specific integrated circuits (ASICs), field programmable gate arrays (FPGAs), a group of processing components, or other suitable electronic processing components. The memory 132 may be one or more devices (e.g., RAM, ROM, Flash memory, hard disk storage) for storing data and/or computer code for completing and/or facilitating the various processes described herein. Memory 132 may be or include non-transient volatile memory, non-volatile memory, and non-transitory computer storage media. Memory 132 may include database components, object code components, script components, or any other type of information structure for supporting the various activities and information structures described herein. The memory 132 may be communicably coupled to the processor 130 and include computer code or instructions for executing one or more processes described herein.

The analysis circuit 134 is configured to receive, react, record, and facilitate modification of events. Accordingly, the analysis circuit 134 comprises a collection endpoint 136, an event response function 138, and an event update function 140. Further, the analysis circuit 134 is coupled to an events database 142.

The collection endpoint 136 may be implemented, for example, as an application programming interface (API) and/or software development kit (SDK), and is structured to receive events via the network interface 126 (e.g., an incoming event from the client device 114 over the network 122). Subsequent to receiving an event, the collection endpoint 136 may store information and details regarding the event (e.g., event condition, event name, event response(s), and device information) in the events database 142. Further, the collection endpoint 136 may then pass the event to the event response function 138 for handling.

The event response function 138 handles events received by the collection endpoint 136 and performs resulting actions associated with the event. For example, an event may be received by the collection endpoint 136 from a client device 114 application 118, which was conditionally activated by the user 112 configuring the application in a certain way, for example making a privacy option selection within the application 118. The related information may then be processed by the collection endpoint 136 and passed to the event response function 138. The event response function 138 may then respond as indicated by the event action(s), which are included in the event information. Illustratively, in the example case of a user 112 making a privacy option selection within the application 118, the action(s) may include: generate a private user group, add the user 112 to the private user group, and remove identifying information of the user 112 from the events database 142. As should be appreciated, the event response function 138 may process event action(s) of varying complexity and comprising a variable amount of steps. In another illustrative example, a client device 112 may be excessively and unnecessarily transmitting data across the network 122 to the event analysis computer system 124, due to an erroneous application 118 configuration. Accordingly, a user 102 associated with a developer device 104 may dynamically propagate an update to application 118 in order to reduce network transmissions of client device 112. The dynamic propagation occurring without an application 118 recode and without user 112 downloading and installing an update to application 118. As should be appreciated, the aforementioned example illustrates significant technological improvements to applications with integrated event frameworks via a reduction in erroneous or excessive hardware utilization.

Still referring to FIG. 1, the event update function 140 receives an application configuration update over the network 122 via the network interface 126 from a developer device 104. The application configuration update may include a variety of data, such as, for example, a modification of an event, an addition of an event, or a deletion of an event. The event update function may then process the configuration update and transmit the configuration update, via the network interface 126, to the event framework 120 of a client device 114. The event update function may also store the configuration update information in the events database 142 for data congruency and logging. Responsive to receiving the updated configuration, the application 118 of the client device 112 may utilize the updated configuration without any further action taken by the user 112 and without any requisite update of the application 118, hence avoiding the necessary use of greater system resources and infrastructure as well as local client device 114 resources than as required by the transmission of the application configuration update to the event framework 120 of a client device 114. For further understanding, elaboration on the application configuration update will be provided in following sections.

The events database 142 is structured to hold, store, categorize, and/or otherwise serve as a repository for information associated with events from a client device 114. For example, the event database 142 may be structured to retrievably store information originating from previously generated events (e.g., generated user groups, application 118 usage statistics, event statistics, user 112 opt-ins, and application 118 configuration instances).

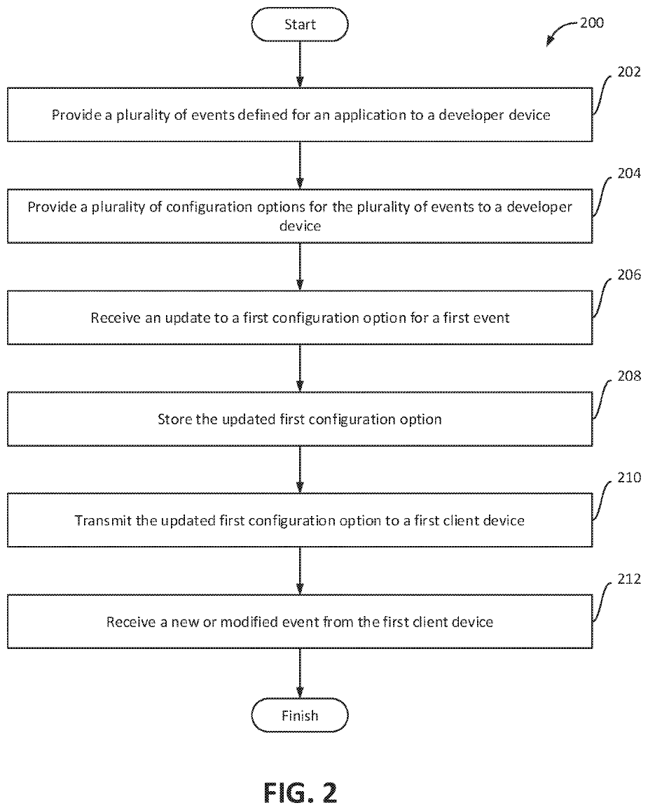

Referring to FIG. 2, a flow diagram for a method 200 for dynamically propagating a configuration update is shown according to an illustrative implementation. The method 200 begins at step 202 where a plurality of events defined for an application 118 are provided to a developer device 104. For example, the plurality of events may include all events currently monitored on the application 118. The plurality of events may be provided to a developer device 104, for example, via a graphical user interface (GUI) or through a web-based application. The method 200 continues at step 204 by providing a plurality of configuration options for the plurality of events to the developer device 104. For example, the plurality of configuration options may include items such as event names, event conditional parameters, event actions, and further options to create new events and delete existing events. In some instances, the user 102 of the developer device 104 may then select a first event to update a configuration for, from the plurality of events.

Once the user 102 has selected a first event to update, at step 206, the method continues by receiving an update to a first configuration option for the first event. In some instances, the update to the first configuration option may change the name of the first event, the conditional parameters which invoke the first event, or it may cause the first event to spawn one or more additional events subsequent to activation of the first event. In other instances, the update to the first configuration option may disable or delete the first event.

Next, at step 208, the received update to the first configuration option may be retrievably stored in the events database 142. In some implementations, a historical log of all configuration option updates may be stored in the events database. The historical log may provide an accurate chronological detailing of all developer device changes made to the configuration options. The chronological detailing may include items such as the developer device information (e.g., geographic location, hardware details, operating system details, etc.), the user associated with the developer device, the time and date of the update, and enterprise details (e.g., the update was made on behalf of a marketing team request). Further, in some instances, the historical log may also be used to revert configuration option updates or re-implement a previous update (e.g., the developers may wish for certain configuration options seasonally and are facilitated to select, for example, last summer's options without having to recreate them).

Continuing at step 210, the configuration option update received at step 206 is transmitted to the client device 114. The client device 114 may implement the configuration update without any action taken by the user 112. Further, the client device 114 may implement the configuration update without updating or altering the code associated with the application 118. Instead, the update may be processed by the event framework 120 and effect the application 118 indirectly.

Lastly, at step 212, the new or modified event associated with the configuration option update received at step 206 is generated by the event framework 120 of the client device 114, and received by the collection endpoint 136. For example, an event may be conditionally activated in response to a user 112 spending a predetermined amount of time (e.g., two minutes) on a specific screen of the application 118. The developer associated with the developer device may have noticed that the time threshold was erroneously set to twenty minutes and thus corrected the error with a configuration option update. Step 212 may then start receiving events from the user 112 utilizing the correct two minute time period as the conditional parameter.

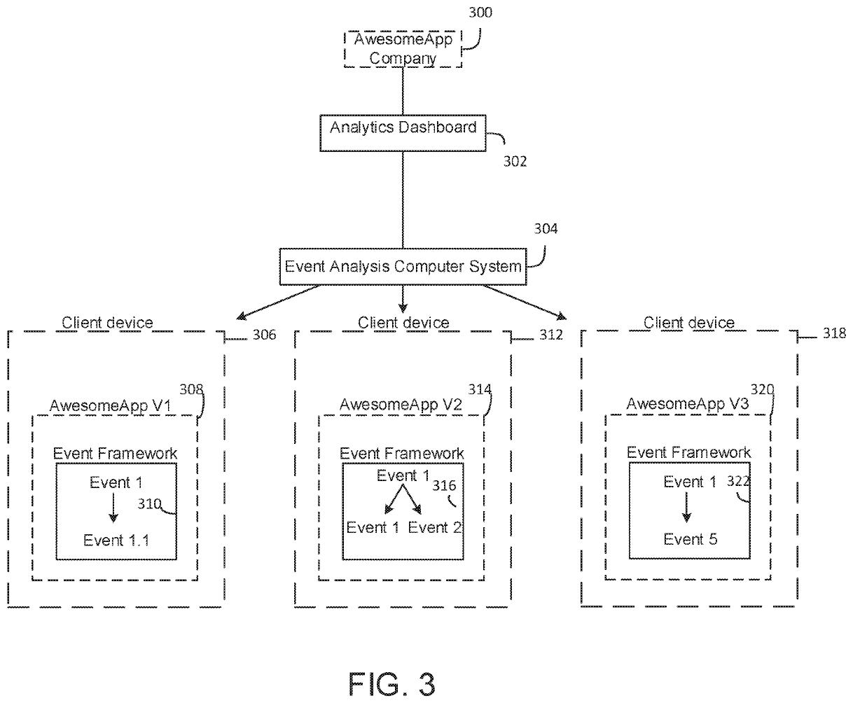

Referring to FIG. 3, a schematic design of an illustrative use of the event analysis computer system is shown. An example application 118 author is depicted at 300. The application 118 author may be any individual, enterprise, or otherwise proprietor of an application 118 ran on a client device 114.

In some instances, the proprietor 300 may access an analytics dashboard 302 in order to view events and modify configuration options. The analytics dashboard 302 may be accessed, for example, as a GUI or a web-based application. The proprietor 300 may then update a first configuration option for a first event using the analytics dashboard 302, the update similar to the process described at 206. In some implementations, the analytics dashboard 302 may include an option to provide parameters which designate a desired audience or group of recipients to receive the configuration update, such as a data or version stream selector. The data stream selector may enable a developer device to target recipients based on predetermined audiences (e.g., iOS users, Android users, etc.). The version selector may enable a developer device to identify the intended recipients based on the version of the application 118 running on the client device 114.

The configuration update selected via the analytics dashboard 302 may then be transmitted to the event analysis computer system 304. The event analysis computer system 304 may be structured and operate similarly to the event analysis computer system 124. The event update function 140 may process the configuration option update and transmit to the recipient client devices.

In one example, the event analysis computer system 304 may receive a configuration option update to rename an event on any client device 114 that is running version 1 of the application 118. The event analysis computer system 304 may then transmit the configuration update to the client device 306 as it is currently running version 1 308 of the application 118. The event framework 310 of application 118 version 1 308 may then process the configuration update and cause an event 1 to be renamed to event 1.1. The event may still function the same, containing the same conditional parameters and associated actions. Client devices 312 and 318 may not receive any configuration updates as they are running different versions of the application 118.

In another example, the event analysis computer system 304 may receive a configuration option update which causes an event on any client device 114 that is running version 2 of the application 118 to generate an additional synthetic event in response to the original event's activation. The event analysis computer system 304 may then transmit the configuration update to the client device 312 as it is currently running version 2 314 of the application 118. The event framework 316 of application 118 version 2 314 may then process the configuration update and cause any conditional parameters which activate event 1 to also generate an event 2. Client devices 306 and 318 may not receive any configuration updates as they are running different versions of the application 118.

In another example, the event analysis computer system 304 may receive a configuration option update which causes an event on any client device 114 that is running version 3 of the application 118 to transform an original event into another event. The event analysis computer system 304 may then transmit the configuration update to the client device 318 as it is currently running version 3 320 of the application 118. The event framework 322 of application 118 version 3 322 may then process the configuration update and cause event 1 to be transformed into event 5. The transformed event 5 may contain modified conditional parameters and actions. Client devices 306 and 312 may not receive any configuration updates as they are running different versions of the application 118.

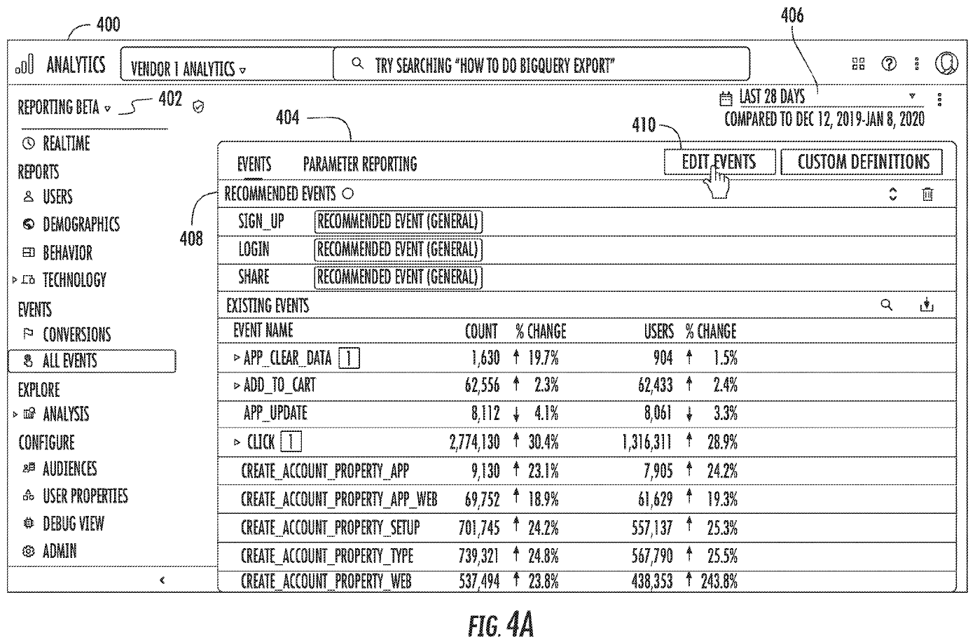

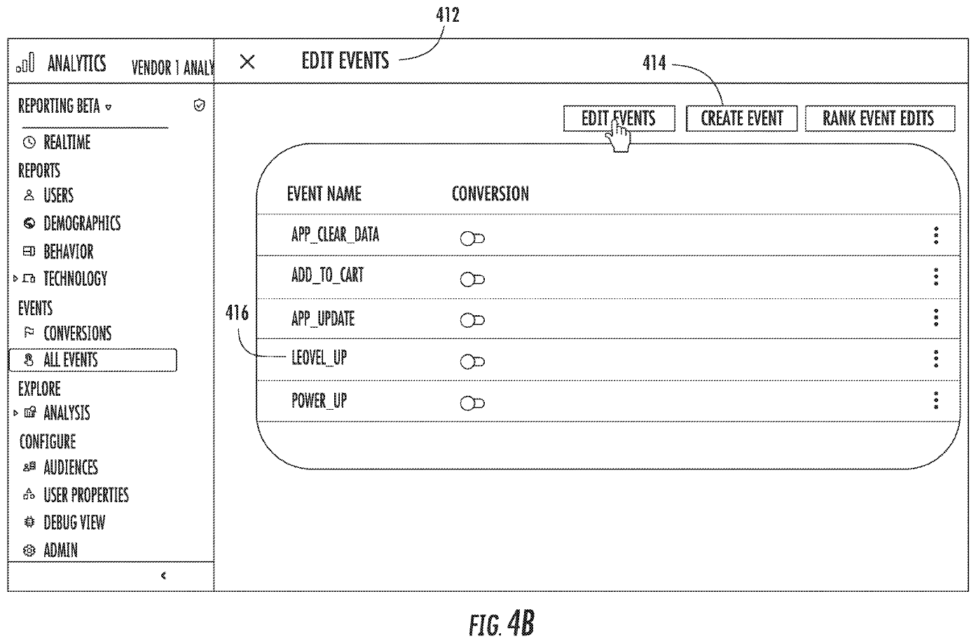

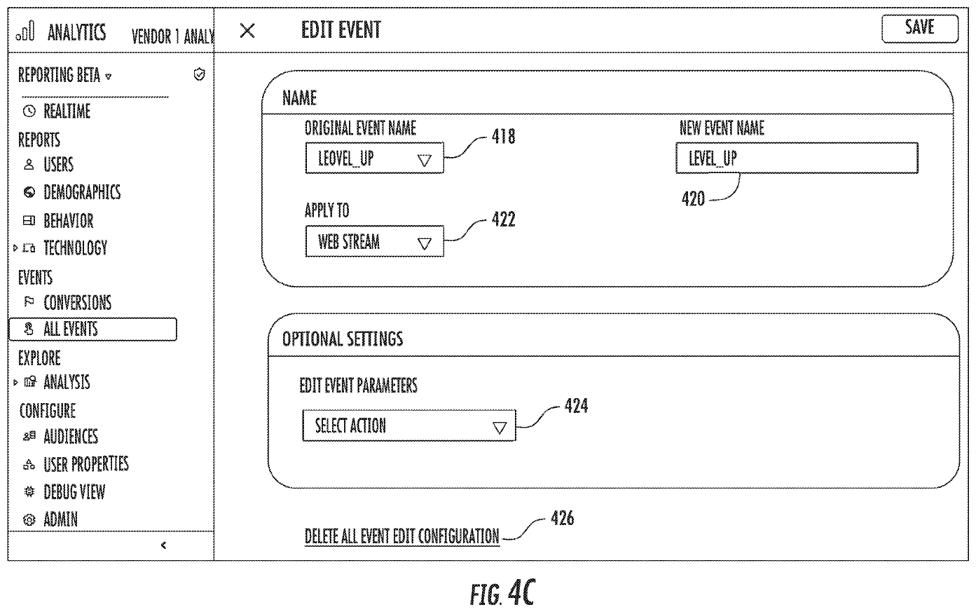

Referring to FIG. 4A, a sample illustrative implementation of a web-based analytics dashboard 400 is shown. In some instances, a reporting dashboard is incorporated at 402. This may enable a developer associated with a developer device 104 to generate reports regarding events which have transpired and the information associated therein. The reports may utilize various predetermined categories in order to filter information or be generated according to custom parameters.

A general event dashboard is indicated by 404, including event and reporting snippets. In some instances, this may include a real-time display of existing events and their statistical significance (e.g., quantity of activations, quantity of unique users who have activated the event, a percent change relative to a predetermined time period). In some implementations, the predetermined time period for which the reporting dashboard considers data may be modified at 406.

The analytics dashboard 400 may also contain a recommend events section 408. These recommend events may include popular events utilized by application 118 authors. For example, events are indicated at 408 which represent a user signing up, logging in, or sharing an item to social media.

The button represented by item 410 may enable a developer associated with a developer device 104 to access an event editing menu.

Now referring to FIG. 4B, according to some implementations, an example event editing menu 412 is shown. A list of existing events may be displayed and selected in order to edit the name, conditional parameters, and action(s) associated with the event.

The button represented by item 414 may enable a developer associated with a developer device 104 to create new events. In some instances, creating a new event may cause the new event to be displayed on the general event dashboard 404.

An example event containing a typo is indicated at 416, named “LEOVEL_UP”. The developer associated with a developer device 104 may select this event and cause an event specific editing menu to be shown.

Now referring to FIG. 4C, according to some implementations, an event specific editing menu is shown. For example, an original event name drop-down menu is indicated by 418. The drop-down menu may enable a developer associated with a developer device 104 to view all names previously associated with the event. These names may be retrieved from the historical log stored in the events database 142.

An example new name field is indicated by 420. A developer associated with a developer device 104 may rename the event in this section and may cause both the current and newly named event to be snapshotted for inclusion in the historical log, stored in the events database 142.

In some instances, a data stream selector is made available at 422. The data stream selector 422 may, for example, enable a developer associated with a developer device 104 to select a target recipient audience for the configuration update.

In other instances, a selection item is made available for editing event parameters at 424. The selection item 424 includes a drop-down menu enabling a developer associated with a developer device 104 to select an action and the conditional parameters associated with the event.

In another instance, a delete all event configurations option is made available at 426. This item may enable a developer associated with a developer device 104 to remove all configurations associated with the event.

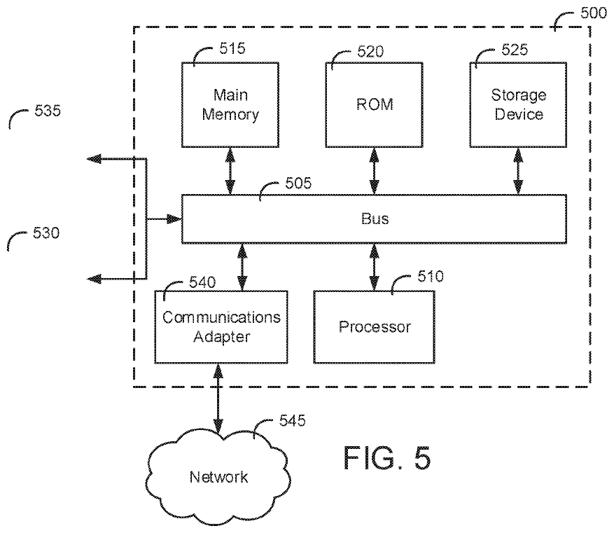

Referring now to FIG. 5, a computer system 500 is shown that can be used, for example, to implement an illustrative developer device 104, an illustrative client device 112, an illustrative event analysis computer system 124, and/or various other illustrative systems described in the present disclosure. The computing system 500 includes a bus 505 or other communication component for communicating information and a processor 510 coupled to the bus 505 for processing information. The computing system 500 also includes main memory 515, such as a random access memory (RAM) or other dynamic storage device, coupled to the bus 505 for storing information, and instructions to be executed by the processor 510. Main memory 515 can also be used for storing position information, temporary variables, or other intermediate information during execution of instructions by the processor 510. The computing system 500 may further include a read only memory (ROM) 520 or other static storage device coupled to the bus 505 for storing static information and instructions for the processor 510. A storage device 525, such as a solid state device, magnetic disk or optical disk, is coupled to the bus 505 for persistently storing information and instructions.

The computing system 500 may be coupled via the bus 505 to a display 535, such as a liquid crystal display, or active matrix display, for displaying information to a user. An input device 530, such as a keyboard including alphanumeric and other keys, may be coupled to the bus 505 for communicating information, and command selections to the processor 510. In another implementation, the input device 530 has a touch screen display 535. The input device 530 can include a cursor control, such as a mouse, a trackball, or cursor direction keys, for communicating direction information and command selections to the processor 510 and for controlling cursor movement on the display 535.

In some implementations, the computing system 500 may include a communications adapter 540, such as a networking adapter. Communications adapter 540 may be coupled to bus 505 and may be configured to enable communications with a computing or communications network 545 and/or other computing systems. In various illustrative implementations, any type of networking configuration may be achieved using communications adapter 540, such as wired (e.g., via Ethernet), wireless (e.g., via Wi-Fi, Bluetooth, etc.), pre-configured, ad-hoc, LAN, WAN, etc.

According to various implementations, the processes that effectuate illustrative implementations that are described herein can be achieved by the computing system 500 in response to the processor 510 executing an arrangement of instructions contained in main memory 515. Such instructions can be read into main memory 515 from another computer-readable medium, such as the storage device 525. Execution of the arrangement of instructions contained in main memory 515 causes the computing system 500 to perform the illustrative processes described herein. One or more processors in a multi-processing arrangement may also be employed to execute the instructions contained in main memory 515. In alternative implementations, hard-wired circuitry may be used in place of or in combination with software instructions to implement illustrative implementations. Thus, implementations are not limited to any specific combination of hardware circuitry and software.

Although an example processing system has been described in FIG. 5, implementations of the subject matter and the functional operations described in this specification can be carried out using other types of digital electronic circuitry, or in computer software, firmware, or hardware, including the structures disclosed in this specification and their structural equivalents, or in combinations of one or more of them.

Implementations of the subject matter and the operations described in this specification can be carried out using digital electronic circuitry, or in computer software embodied on a tangible medium, firmware, or hardware, including the structures disclosed in this specification and their structural equivalents, or in combinations of one or more of them. Implementations of the subject matter described in this specification can be implemented as one or more computer programs, i.e., one or more modules of computer program instructions, encoded on one or more computer storage medium for execution by, or to control the operation of, data processing apparatus. Alternatively or in addition, the program instructions can be encoded on an artificially-generated propagated signal, e.g., a machine-generated electrical, optical, or electromagnetic signal that is generated to encode information for transmission to suitable receiver apparatus for execution by a data processing apparatus. A computer-readable storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate components or media (e.g., multiple CDs, disks, or other storage devices). Accordingly, the computer storage medium is both tangible and non-transitory.

The operations described in this specification can be implemented as operations performed by a data processing apparatus on data stored on one or more computer-readable storage devices or received from other sources.

The term “data processing apparatus” or “computing device” encompasses all kinds of apparatus, devices, and machines for processing data, including by way of example, a programmable processor, a computer, a system on a chip, or multiple ones, or combinations of the foregoing. The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example, semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, implementations of the subject matter described in this specification can be carried out using a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Implementations of the subject matter described in this specification can be carried out using a computing system that includes a back-end component, e.g., as a data server, or that includes a middleware component, e.g., an application server, or that includes a frontend component, e.g., a client computer having a graphical user interface or a Web browser through which a user can interact with an implementation of the subject matter described in this specification, or any combination of one or more such backend, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some implementations, a server transmits data (e.g., an HTML page) to a client device (e.g., for purposes of displaying data to and receiving user input from a user interacting with the client device). Data generated at the client device (e.g., a result of the user interaction) can be received from the client device at the server.

In some illustrative implementations, the features disclosed herein may be implemented on a smart television module (or connected television module, hybrid television module, etc.), which may include a processing circuit configured to integrate internet connectivity with more traditional television programming sources (e.g., received via cable, satellite, over-the-air, or other signals). The smart television module may be physically incorporated into a television set or may include a separate device such as a set-top box, Blu-ray or other digital media player, game console, hotel television system, and other companion device. A smart television module may be configured to allow viewers to search and find videos, movies, photos and other content on the web, on a local cable TELEVISION channel, on a satellite TELEVISION channel, or stored on a local hard drive. A set-top box (STB) or set-top unit (STU) may include an information appliance device that may contain a tuner and connect to a television set and an external source of signal, turning the signal into content which is then displayed on the television screen or other display device. A smart television module may be configured to provide a home screen or top level screen including icons for a plurality of different applications, such as a web browser and a plurality of streaming media services (e.g., Netflix, Vudu, Hulu, etc.), a connected cable or satellite media source, other web “channels”, etc. The smart television module may further be configured to provide an electronic programming guide to the user. A companion application to the smart television module may be operable on a mobile computing device to provide additional information about available programs to a user, to allow the user to control the smart television module, etc. In alternate implementations, the features may be implemented on a laptop computer or other personal computer, a smartphone, other mobile phone, handheld computer, a tablet PC, or other computing device.

While this specification contains many specific implementation details, these should not be construed as limitations on the scope of any inventions or of what may be claimed, but rather as descriptions of features specific to particular implementations of particular inventions. Certain features that are described in this specification in the context of separate implementations can also be carried out in combination or in a single implementation. Conversely, various features that are described in the context of a single implementation can also be carried out in multiple implementations, separately, or in any suitable subcombination. Moreover, although features may be described above as acting in certain combinations and even initially claimed as such, one or more features from a claimed combination can, in some cases, be excised from the combination, and the claimed combination may be directed to a subcombination or variation of a subcombination. Additionally, features described with respect to particular headings may be utilized with respect to and/or in combination with illustrative implementations described under other headings; headings, where provided, are included solely for the purpose of readability and should not be construed as limiting any features provided with respect to such headings.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products embodied on tangible media.

Thus, particular implementations of the subject matter have been described. Other implementations are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous. While this specification contains many specific implementation details and/or arrangement details, these should not be construed as limitations on the scope of any inventions or of what may be claimed, but rather as descriptions of features specific to particular implementations and/or arrangements of the systems and methods described herein. Certain features that are described in this specification in the context of separate implementations and/or arrangements can also be implemented and/or arranged in combination in a single implementation and/or arrangement. Conversely, various features that are described in the context of a single implementation and/or arrangement can also be implemented and arranged in multiple implementations and/or arrangements separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

1-20. (canceled)

21. A method for propagating event monitoring configurations to distributed client devices in a networked environment, the method comprising:
providing, by one or more processing circuits of an event analysis computer system, to a developer device, a dashboard interface configured to display a plurality of events defined for a mobile application;
providing, by the one or more processing circuits, to the developer device, a plurality of configuration options for the events, wherein the plurality of configuration options comprises parameters, wherein the dashboard interface is configured to provide, responsive to a selection of at least one event of the plurality of events, at least one input field for updating at least one parameter associated with the at least one event;
receiving, by the one or more processing circuits, from the developer device, an update to a first configuration option of the plurality of configuration options for a first event of the plurality of events and a first parameter associated with the update;
processing, by the one or more processing circuits, the updated first configuration option for transmission to a first client device of a plurality of client device running the mobile application;
transmitting, by the one or more processing circuits, the updated first configuration option to the first client device, wherein the updated first configuration option causes the mobile application to monitor data of the mobile application for occurrence of the first parameter; and
receiving, by the one or more processing circuits, from the first client device responsive to the first client device detecting the occurrence of the first parameter, a new event or a modified event based on the updated first configuration option.

22. The method of claim 21, wherein the plurality of events are provided in a selectable list in the dashboard interface.

23. The method of claim 21, wherein the plurality of configuration options comprises at least one of: an event name option, an event conditional parameter option, an event action option, a new event option, or a delete event option.

24. The method of claim 21, wherein the dashboard interface provides a plurality of selectable interface elements respectively for the plurality of configuration options.

25. The method of claim 21, wherein the updated first configuration option causes the first event to trigger one or more additional events.

26. The method of claim 25, wherein the one or more additional events comprises a synthetic event.

27. The method of claim 21, comprising:
receiving, by the one or more processing circuits, an event activated by an option selected by a user of the first client device.

28. The method of claim 21, wherein the dashboard interface comprises a real-time display of existing events and statistics descriptive of the existing events.

29. The method of claim 28, wherein the statistics comprise at least one of: a quantity of activations, a quantity of unique users who have activated the event, or a percent change relative to a predetermined time period.

30. The method of claim 21, wherein the dashboard interface comprises a listing of one or more recommended events.

31. The method of claim 30, comprising:
determining, by the one or more processing circuits and based on utilization of events by application developers, the one or more recommended events.

32. The method of claim 21, comprising:
updating, by the one or more processing circuits, a historical log to include the updated first configuration option.

33. The method of claim 32, wherein the historical log stores prior configuration options for the first event, and wherein the prior configuration options are displayed, in the dashboard interface, for selection for updating the first event.

34. The method of claim 32, wherein the dashboard interface is configured to, responsive to an input and using the historical log, revert configuration option updates or re-implement a previous update.

35. The method of claim 21, wherein the dashboard interface is web-based and accessible by the developer device for interacting with the event analysis computer system.

36. The method of claim 21, wherein the updated first configuration option corresponds to a data stream selection indicating a first data stream category of the mobile application from among a plurality of data stream categories.

37. The method of claim 21, wherein transmitting the updated first configuration option to the first client device comprises:
transmitting, by the one or more processing circuits, the updated first configuration option responsive to determining a data stream category associated with the first client device is the first data stream category.

38. The method of claim 21, wherein the parameters comprise a plurality of Boolean operators and a plurality of conditions, and wherein the dashboard interface provides for selection, on the developer device, of multipart conditional parameters.

39. A computing system for propagating event monitoring configurations to distributed client devices in a networked environment, the system comprising:
one or more processors; and
one or more non-transitory computer-readable media storing instructions that are executable to cause the one or more processors to perform operations, the operations comprising:
providing a dashboard interface configured to display a plurality of events de-fined for a mobile application;
providing, to a developer device, a plurality of configuration options for the events, wherein the plurality of configuration options comprises parameters, wherein the dashboard interface is configured to provide, responsive to a selection of at least one event of the plurality of events, at least one input field for updating at least one parameter associated with the at least one event;
receiving, from the developer device, an update to a first configuration option of the plurality of configuration options for a first event of the plurality of events and a first parameter associated with the update;
processing the updated first configuration option for transmission to a first client device of a plurality of client device running the mobile application;
transmitting the updated first configuration option to the first client device, wherein the updated first configuration option causes the mobile application to monitor data of the mobile application for occurrence of the first parameter; and
receiving, from the first client device responsive to the first client device detecting the occurrence of the first parameter, a new event or a modified event based on the updated first configuration option.

40. One or more non-transitory computer-readable media storing instructions that are executable to cause one or more processors to perform operations for propagating event monitoring configurations to distributed client devices in a networked environment, the operations comprising:
providing a dashboard interface configured to display a plurality of events defined for a mobile application;
providing, to a developer device, a plurality of configuration options for the events, wherein the plurality of configuration options comprises parameters, wherein the dashboard interface is configured to provide, responsive to a selection of at least one event of the plurality of events, at least one input field for updating at least one parameter associated with the at least one event;
receiving, from the developer device, an update to a first configuration option of the plurality of configuration options for a first event of the plurality of events and a first parameter associated with the update;
processing the updated first configuration option for transmission to a first client device of a plurality of client device running the mobile application;
transmitting the updated first configuration option to the first client device, wherein the updated first configuration option causes the mobile application to monitor data of the mobile application for occurrence of the first parameter; and
receiving, from the first client device responsive to the first client device detecting the occurrence of the first parameter, a new event or a modified event based on the updated first configuration option.
